(19) United States
(12) Patent Application Publication
(10) Pub. No.: US 2003/0056209 A1
(43) Pub. Date: Mar. 20, 2003

(54) Video signal timer switch

(76) Inventors: Norman R. Buck, Old Town, ME (US); Kympton Lovley, Hampden, ME (US); John Elliott, Winterport, ME (US)

Correspondence Address: John P. McGonagle, Law Offices of John P. McGonagle, 800 Hingham Street -2N, Rockland, MA, 02370, US

(21) Appl. No.: 09/954,452

(22) Filed: Sep. 18, 2001

(51) Int. Cl. H04N 7/16

(52) U.S. Cl. 725/25; 725/29; 725/80

(57) ABSTRACT

A method and apparatus for manipulating an RF or NTSC video source to control access for video products such as television, cable, satellite, VCR, DVD, and video game devices. An apparatus and method provided by the present invention takes a signal from any one of a number of signal sources and interfaces with the monitor/television/device subject to control. The apparatus and method provides a master control for the amount of time the entertainment source can be accessed and during which times of the day it can be accessed. Within the master control, subsidiary controls can be implemented within master code guidelines. The apparatus also provides its own video signal for on-screen display of functions and timing.

### BACKGROUND OF THE INVENTION

This invention relates generally to video signals, and in particular to a method and apparatus for controlling video signals in and for televisions, VCRs, and video entertainment systems.

Television viewing, and other related forms of program watching and video game playing through the use of external devices connected to a television or other type of CRT-based apparatus, has long been a source of entertainment for children and adults alike. However, over the course of a long period of advancement in television viewing and video game playing, a problem has arisen regarding the amount of time spent watching or using the television and/or video game apparatus.

It has been reported on television news channels, such as the Fox News Network, that the average child who owns a video game system spends an average of ten hours per week playing the video game. The report also determined that the more hours a child spends in front of a video game, the lower their grades are on average. One of the biggest problems with home video game systems is controlling the amount of time a child spends playing it.

Prior art devices have attempted to address this problem. Some devices simply block out certain television channels altogether. Other devices try to control television and video game apparatus by disrupting power to the television and/or video game apparatus. The first type devices do not address the problem of regulating the amount of time available, rather they take an all or nothing approach. The second type device addresses regulation of time available, but creates electronic problems. Turning power on and off to an electronic device severely stresses components within the device. Clocks and timers within the device itself must also be reset.

### SUMMARY OF THE INVENTION

The present invention addresses the limitations of the prior art by providing a method and apparatus for manipulating an RF or NTSC video source to control access for video products such as television, cable, satellite, VCR, DVD, and video game devices. An apparatus and method provided by the present invention takes a signal from any one of a number of signal sources and interfaces with the monitor/television/device subject to control. The apparatus and method provides a master control for the amount of time the entertainment source can be accessed and during which times of the day it can be accessed. Within the master control, subsidiary controls can be implemented within master code guidelines. The apparatus also provides its own video signal for on-screen display of functions and timing.

The present invention not only provides a control for the amount of time a child may use a video game system, but also provides a motivational mechanism as well. The present invention is simple but effective. The present invention interfaces the video game system with a home television. The present invention has a master control with its own password that allows limited access to a main menu. From the menu, the master controller, e.g., parents, set up accounts for one of several children and assign each child their own individual play time. Individual playtime may be expanded or contracted as part of an overall motivation scheme to reward achievement or desired behavior.

As a result, the present invention permits customizing usage patterns for multiple children. The present invention provides direct control of an incoming video signal where other devices enable/disable the power to either or both the video game system and television. The present invention provides a video overlay, so that a game player can clearly see how much time is available without affecting game play. The present invention allows a player to “bank” and “borrow” time to enable longer play. The present invention also permits parental control of time of day usage.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1 is a top view of the apparatus of the invention.

FIG. 2 is a block diagram of the apparatus of the invention.

FIG. 3 is a functional block diagram of the apparatus of the invention.

FIG. 4 is a functional block diagram of another embodiment of the apparatus of the invention.

FIG. 5 is flowchart of the method of the invention;

FIG. 6 is a sample introductory monitor screen according to the invention.

FIG. 7 is a sample master control monitor screen according to the invention.

FIG. 8 is a sample player control monitor screen according to the invention.

### DETAILED DESCRIPTION OF THE INVENTION

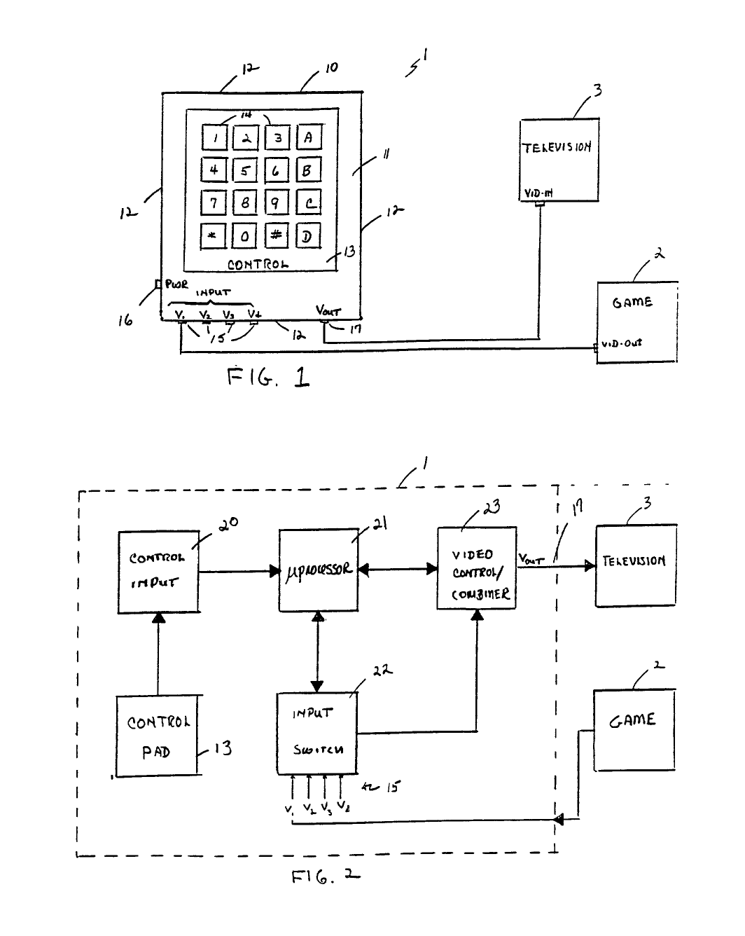

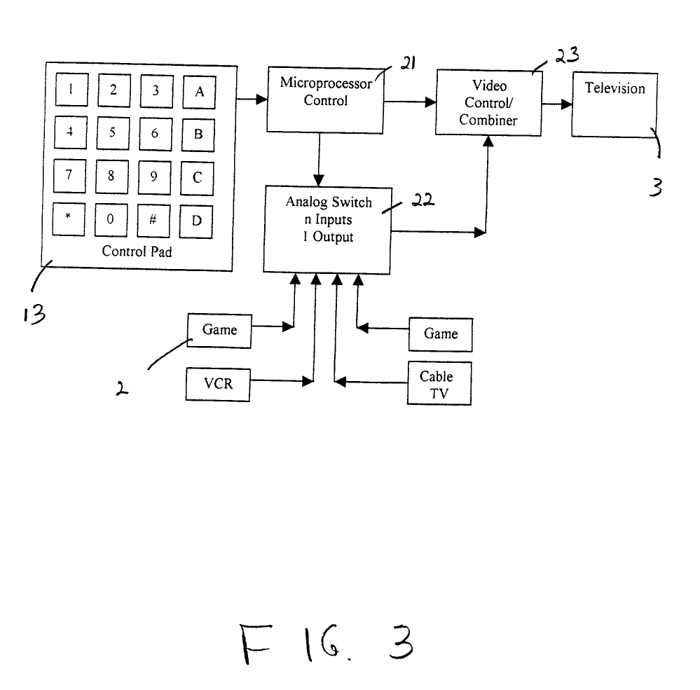

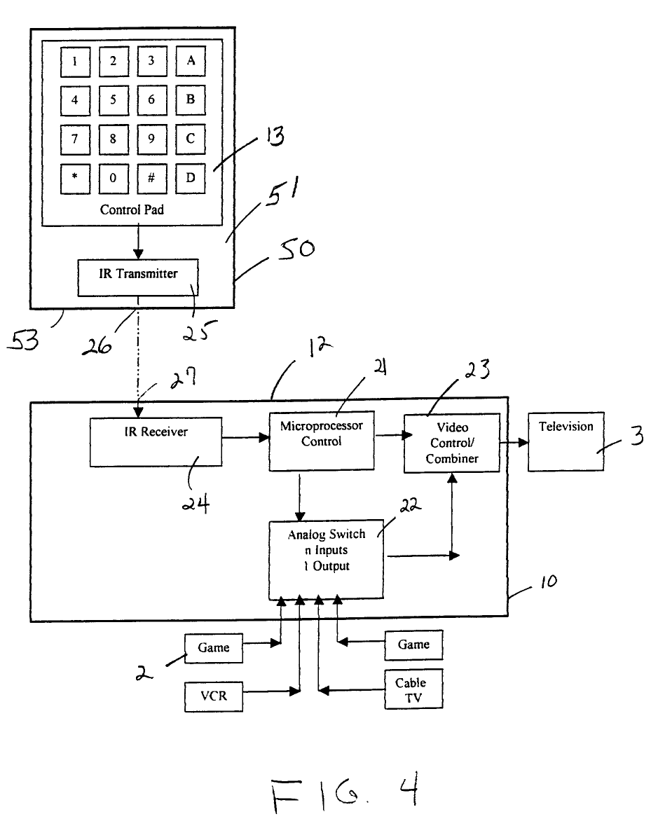

Referring to the drawings in detail wherein like elements are indicated by like numerals, there is shown in FIGS. 1, 2 and 3, a video signal timer switch 1 embodying the principles of the present invention. For purposes of exposition, the invention will be described in terms of a video game system 2 using a television 3 for display and sound purposes. Most video game systems sold on the market today are adapted to using a home television for display and sound purposes. This substantially lowers the cost of the video game system since nearly all homes will have at least one television.

The switch 1 is comprised of a generally rectangular housing 10 with a top 11 and four sides 12. The housing 10 has a control pad 13 with various keys 14 adapted for entering codes and commands into the invention 1 contained within and protruding through said housing top 11. One of the housing sides 12 has a plurality of video input jacks 15 adapted to receive video outputs from devices such as VCR and DVD players, televisions, video game devices, and the like. In the embodiment shown, four input jacks 15 are provided so that four devices may be simultaneously connected to the housing 10. For exposition purposes, a video game device 2 has its video output connected to one of the video input jacks 15 of the switch 1. In other embodiments of the invention, the housing 10 can be configured to accept as few as one or as many more as may be desired. Power may be supplied to the invention by means of external DC or AC, or internal battery power, or a combination of both, all such power supplies and techniques being well known in the prior art. In this embodiment, the housing has a power jack 16 on a housing side 12 adapted to receive DC power from an external source. One of the housing sides 12 also has a video output jack 17 adapted to bring the invention output to the “Video In” of the device being controlled, e.g., a television 3. Within the housing 10, an electronic control input module 20 is provided which is adapted to receiving signals from the control pad 13 and translating the signals into control signals for a microprocessor 21 within the housing 12. The microprocessor 21 controls an input switch 22 which selects a desired input source by activating an appropriate input jack 15. The video signal from the video game device 2 is brought into the housing 12 through the selected input jack 15 and passed through to a video controller/combiner 23. The output from the video controller/combiner 23 is made available to the housing output jack 17. The output from the output jack 17 is passed to the “Video In” jack of a television 3. The microprocessor 21 also controls the video controller/combiner 23. The microprocessor 21 essentially determines when the video controller/combiner 23 passes the signal from the input switch 22 through to the housing output jack 17, and for how long a period of time. The microprocessor 21 is also adapted to providing a video signal of its own to the video controller/combiner 23 either to be combined with the signal from the input switch 22 or to replace the signal from the input switch 22 in its entirety.

In another embodiment of the invention, the control pad 13 is remoted from the switch housing 10, thereby providing a remote control. This embodiment is illustrated in FIG. 4. The original housing 10 replaces the control pad 13 with an infrared (IR) receiver 24 and means 27 along one of its sides 12 for receiving an IR signal. Functionally, everything else remains the same. The control pad 13 is incorporated into its own housing 50, said housing having a top 51, a bottom (not shown) and four sides 53. The control pad 13 protrudes from said housing top 51. An IR transmitter 25 is incorporated into the housing 50, is electronically connected to the control pad 13, and has means 26 along one of the housing sides 19 for transmitting an infrared signal to the IR receiver 24.

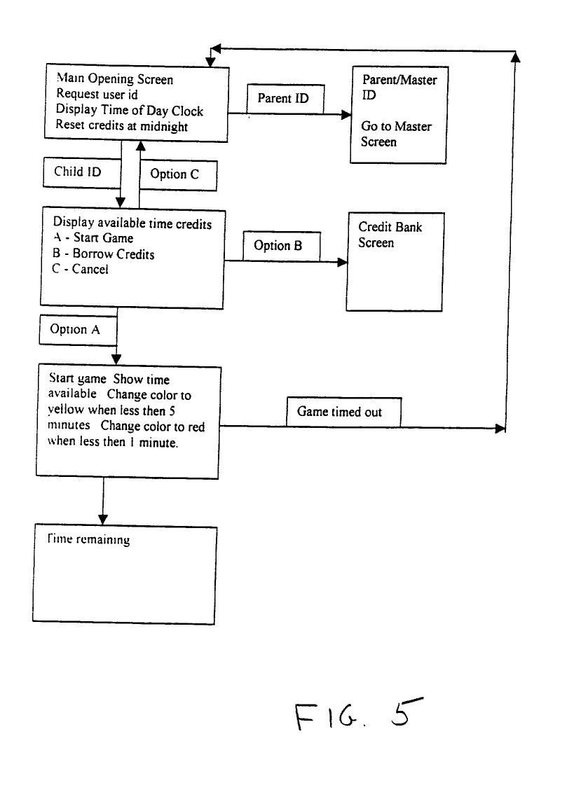

Referring generally to the figures, and more particularly to FIGS. 5-8 which illustrate the method of the present invention, an invention user enters a code by means of the control pad 13. The microprocessor 21 is activated by the code and makes available through the video controller/combiner 23 various screen displays on the television 3 presenting available features. The user then selects an appropriate or desired option and the microprocessor 21 enables the optional signal to be displayed on the television 3.

An example of an initial opening screen 30 is shown in FIG. 5. The initial screen 30 will request a user identifier and/or a password 31. This information is entered via the control pad 13.

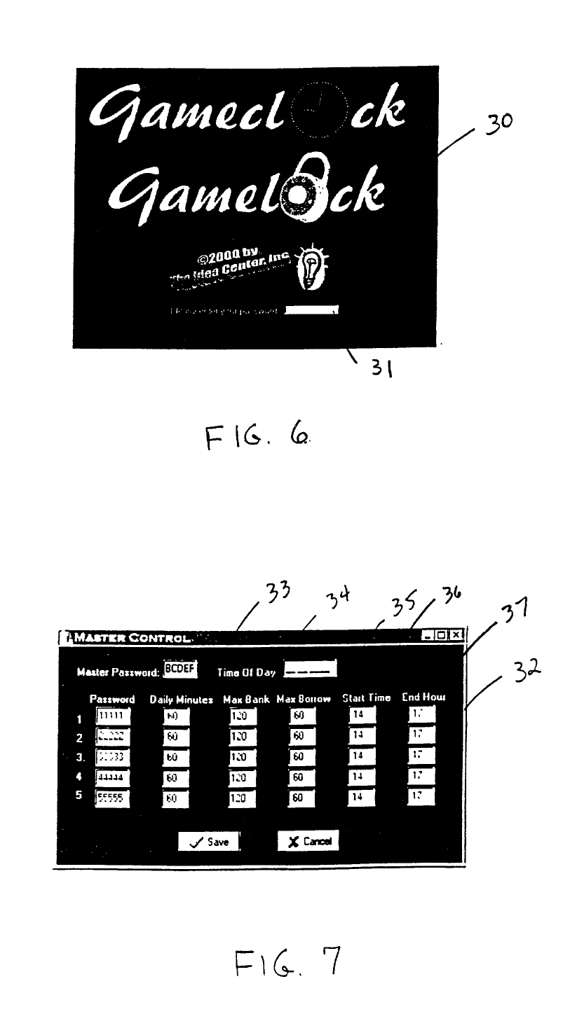

If the information 31 entered signals that it is a master control identifier, a master control screen 32, an example of which is shown in FIG. 6, is presented on the television. The master control screen 32 permits the master controller, e.g., parent, to control usage patterns for up to five children. other embodiments of the invention may have more or less children. Each child is issued a unique password. “Daily Minutes” 33 is the amount of time added each day for each selected child. “Max Bank” 34 is the amount of time that can be stored up. “Max Borrow” 35 is the maximum time that can be borrowed per twenty-four hour period. The total allowed daily play time would be Daily Minutes 33 plus Max. Borrow 35. The daily time period during which a child may be allowed to play may be set by means of the “Start Time” 36 and “End Hour” 37 controls. Control may also be extended and varied according to day of the week. Other relevant control features may also be added.

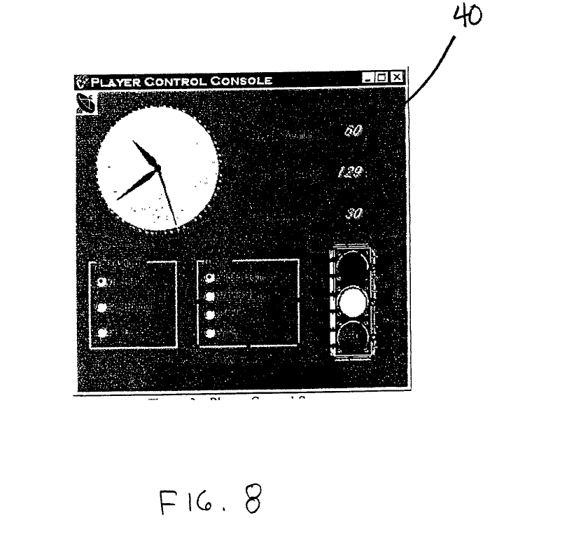

If the information 31 entered signals that it is an individual player, i.e., child, a player control screen 40, an example of which is shown in FIG. 7, is presented on the television monitor 2. The player control screen 40 permits the player to select the desired video source, i.e., input jack 15 The player control screen 40 will indicate the playing minutes available, the amount in the bank, and the amount available to be borrowed. The player can play with what has been allocated or can add to the allocated amount by borrowing. The player would then start the game and play it for some period of time. The player may check the amount of time available for playing by entering an appropriate code. Alternatively, the amount of time available may be continuously or intermittently displayed on a corner of the television screen. Various options may be implemented to signal the [player that the amount of time allocated may be about to end. For example, the screen color could be made to change to yellow when less than five minutes remain in the player's allocated playing time. The screen color could then be made to change to red when less than a minute remained in the player's allocated playing time. When the allocated time is used, the game would be interrupted. The player's control screen would then re-appear indicating that the player's allocated time had been used up. The player could then borrow more time if available or desired. Alternatively, after a designated period of time, the initial screen would re-appear.

Since it is highly desirable that the master control information remain in the switch 1, power must remain available to the housing 10 and components therein. If an “ON/OFF” switch were incorporated into the housing 10, a battery would be required within the housing 10 to maintain clocks, timers and tables within the microprocessor 21.

It is understood that the above-described embodiments are merely illustrative of the application. Other embodiments may be readily devised by those skilled in the art which will embody the principles of the invention and fall within the spirit and scope thereof.

We claim:

1. A video signal timer switch, comprising, in combination:
a television monitor;
an incoming signal source;
a video switch interconnecting said television monitor and said signal source, said switch comprising:
a housing comprising:
a top, a bottom and four sides interconnecting said top and bottom;
a control pad within said housing and protruding through said housing top, said pad being comprised of a plurality of keys adapted to enter codes and commands into the video switch;
a plurality of video input jacks each adapted to receive said incoming signal source;
a video output jack adapted to operatively connect said signal source to said television monitor;
an electronic control input module within said housing, said control module adapted to receive signals from said control pad, translate said signals into control signals and pass said control signals to a microprocessor within the housing;
a microprocessor within said housing and interconnected to said control module, wherein said microprocessor is adapted to receive said control signals from the control pad;
an input switch within said housing interconnected to said microprocessor, said input switch adapted to receive and select an incoming signal source; and
a video controller/combiner within said housing and interconnected to said microprocessor, said input switch, and said video output jack, said controller/combiner adapted to interconnect said incoming signal source with said television monitor.

2. A video signal timer switch as recited in claim 1, further comprising:
programming means within said microprocessor wherein said programming means allots an amount of time in which said video controller/combiner interconnects said incoming signal source with said television monitor.

3. A video signal timer switch as recited in claim 2, wherein:
said programming means includes means for displaying visual indicia on said television monitor.

4. A video signal timer switch as recited in claim 3, wherein:
said video controller/combiner includes means for combining said visual indicia with said incoming signal source.

5. A video signal timer switch, comprising, in combination:
a television monitor;
an incoming signal source;
a video switch interconnecting said television monitor and said signal source, said switch comprising:
a first housing comprising:
a top, a bottom, and four sides interconnecting said top and bottom;
a control pad within said first housing and protruding through said first housing top, said pad being comprised of a plurality of keys adapted to entering codes and commands into the video switch;
an infrared transmitter within said first housing, electronically connected to said control pad, and having means along one of said sides for transmitting an infrared signal;
a second housing comprising:
a top, a bottom, and four sides interconnecting said top and bottom;
a plurality of video input jacks each of which is adapted to receive said incoming signal source;
a video output jack adapted to operatively connect said signal source to said television monitor;
an infrared receiver within said second housing, and having means along one of said sides for receiving an infrared signal;
an electronic control input module within said second housing and electronically connected to said infrared receiver, said control module adapted to receive signals from said control pad through said infrared transmitter and said infrared receiver, translate said signals into control signals and pass said control signals to a microprocessor within the second housing;
a microprocessor within said housing and interconnected to said control module, wherein said microprocessor is adapted to receive said control signals from said control module;
an input switch within said second housing and interconnected to said microprocessor, said input switch adapted to receive and select an incoming signal source; and
a video controller/combiner within said second housing and interconnected to said microprocessor, said input switch, and said video output jack, said controller/combiner adapted to interconnect said incoming signal source with said television monitor.

6. A video signal timer switch as recited in claim 5, further comprising:
programming means within said microprocessor wherein said programming means allots an amount of time in which said video controller/combiner interconnects said incoming signal source with said television monitor.

7. A video signal timer switch as recited in claim 6, wherein:
said programming means includes means for displaying visual indicia on said television monitor.

8. A video signal timer switch as recited in claim 7, wherein:
said video controller/combiner includes means for combining said visual indicia with said incoming signal source.
